(19) United States
(12) Patent Application Publication
(10) Pub. No.: US 2005/0268567 A1
(43) Pub. Date: Dec. 8, 2005

(54) Wedge-shaped window for providing a pressure differential

(75) Inventors: Daniel J. Devine, Los Gatos, CA (US); Young Jai Lee, Sunnyvale, CA (US)

Correspondence Address: PRITZKAU PATENT GROUP, LLC, 993 GAPTER ROAD, BOULDER, CO, 80303, US

(73) Assignee: Mattson Technology, Inc., Fremont, CA (US)

(21) Appl. No.: 10/631,516

(22) Filed: Jul. 31, 2003

(51) Int. Cl. E06B 3/00

(52) U.S. Cl. 52/204.5

(57) ABSTRACT

As part of a chamber configuration, a window arrangement includes a chamber having an interior. The chamber forms a window aperture having an aperture edge. A window, having a pair of opposing major surfaces and a peripheral sidewall configuration extending between the opposing major surfaces, is received in the window aperture with the peripheral sidewall configuration supported against the aperture edge such that the peripheral sidewall configuration and the aperture edge cooperate in a way which converts at least a portion of a biasing force, that is applied generally normal to the opposing major surfaces of the window, to a direction that is different from, oblique to, or sloped with respect to an applied direction of the biasing force.

### BACKGROUND OF THE INVENTION

The present invention relates generally to a window, that is transparent at least to an approximation, and which is provided within a chamber arrangement for purposes of maintaining a pressure differential across the window while allowing for the transmission of electromagnetic radiation therethrough and, more particularly, to a window having at least a portion of its side margin in a frusto-geometric or wedge shape.

Chamber arrangements which employ a window are often seen in the field of semiconductor processing in which, for example, a semiconductor wafer or substrate is positioned proximate to a window to be subjected to some form of treatment radiation that is caused to pass through the window. One example of such a chamber arrangement is commonly used in a Rapid Thermal Processing (RTP) system in which the treatment object or wafer is heat treated at a sub-atmospheric pressure. A heat source such as, for example, an array of tungsten-halogen lamps is arranged on one side of the window, while the wafer is arranged on the opposite side of the window.

The separation of lamps from the processing environment afforded by a window, in an RTP system, is necessary as the tungsten-halogen lamps, like other lamps energy sources, require active cooling. Such active cooling cannot be accomplished in a sub-atmospheric RTP environment That is, the heating lamps typically can not be collocated in the treatment chamber with the wafer. For proper operation of the tungsten-halogen lamps, which causes the halogen fill gas to recycle evaporate tungsten from the lamp filament, the quartz envelop of the tungsten-halogen lamps should be maintained within a relatively narrow temperature zone. The quartz envelope of the tungsten-halogen lamps typically operates from about 775 to 950° K. Air or nitrogen is typically used to cool/regulate the temperature of the quartz envelope of the tungsten-halogen lamps. Hence, the requirement to regulate the lamp body temperature is one reason that the lamps are typically separated from any sub-atmospheric RTP environment.

While window arrangements are often configured for use in executing semiconductor processes, they are also often provided, and are useful, for supporting a pressure differential to accommodate other purposes. As one example, a window may be provided to facilitate viewing of a chamber interior by an operator or by instrumentation.

Referring to FIG. 1, one prior art window arrangement is illustrated, in an elevational view, generally indicated by the reference number 10. Window arrangement 10 is formed in a chamber 12 having a chamber wall 14. Window arrangement 10 includes a transparent window 16 which is supported by chamber wall 14 and is in the form of a circular, flat disk (not shown), in a plan view. A circular configuration is often used to minimize the volume of the process environment, to minimize the mass, size and cost of the window materials, and to minimize window stress, as will be further discussed. In all of these configurations, however, sidewalls 18 of the window are typically normal to opposing major surfaces 20 and 22 of the window, although their specific shape is relatively unimportant, aside from interference concerns, since they serve no support purpose, but only provide integrity to the overall window structure, as will become still more evident below. In the present example, major surface 20 faces away from a treatment chamber 24 while major surface 22 serves to define a portion of the interior periphery of the treatment chamber.

With continuing reference to FIG. 1, chamber wall 14 defines a window aperture having a peripheral support step 26. Installation of window 16 into the window aperture causes a peripheral edge margin of inner major surface 22 to be received against a gasket 28 that is positioned against peripheral support step 26. Thereafter, a clamping force that is typically applied using a top clamp 30 which may, in the present example, be in the form of a circular ring. This clamping force serves two purposes: the first purpose is to mechanically position the window within the window aperture, thereby assuring that there is continuous contact between window surface 22, and compression gasket 28, as well as between compression gasket 28, and peripheral support step 26, so that, when the pressure on the side of window 22, facing the treatment chamber is reduced, a seal exists between 26, 28 and 22. In this way, the required vacuum integrity and leak rate, is achieved. The second purpose is to allow the thickness of the window to be reduced, as compared to an undamped prior art window. The latter has not been shown, but for present purposes, it is sufficient to note that stress considerations mandate the use of a relatively thicker window in such an unclamped configuration. Reducing the thickness of the window, by using a clamped configuration, is desirable to reduce the cost of the window and to allow the distance from the atmospheric side of the window 20 to a location in the treatment chamber to be minimized.

Top clamp 30 is configured to simultaneously overlap an outer surface 32 of chamber wall 14 and a peripheral edge margin 31 of major surface 20. Gasket 28 may be formed from a compressible polymer gasket material so as to eliminate direct contact between quartz and metal on the side of major surface 22, usually facing the lower pressure environment It is noted that direct contact between a quartz surface and a metal surface normally results in point contact between the quartz and the metal. This direct point contact can result in very high stress loads at the point contact These high stress points can lead to fracture of the quartz when a pressure and/or thermal differential is created across the quartz window. If desired, a compression gasket (not shown) may be positioned between top clamp 30 and the peripheral edge portion of outer major surface 20. Top clamp 30 is biased against peripheral edge portion 31 of outer major surface 20, as well as against outer surface 32 of chamber wall 14, for example, by clamping screws 36 which are received in threaded openings 38 that are formed in chamber wall 14.

In the exemplary case of an RTP system, the window and support structure should securely and safely maintain a contemplated pressure differential (usually one atmosphere) between the substrate process environment and the lamps used to heat the substrate. Moreover, a relatively large three-dimensional thermal gradient commonly develops within the window, as a result of heating by the lamps and through thermal radiation from the substrates being processed, as will be further described.

For an RTP application, heating of the window can be attributed, in part, to a lamp energy spectrum which contains some energy that is absorbed by the quartz (as quartz is highly absorbing beyond a wavelength of approximately 3.5 μm). Additionally, a hot substrate radiates energy that is mostly in the mid to far infrared region of the electromagnetic spectrum and this energy is readily absorbed by the quartz resulting in a thermal gradient through the thickness of the quartz with the center of the quartz surface closest to the substrate being the hottest. At the same time, heat loss at the edge of the window, to the window support structure, leaves the center of the window considerably hotter than its peripheral edge. Accordingly, a first, radial thermal gradient is produced across the width of the window and a second thermal gradient through the thickness of the window.

General Electric (GE) Company™ currently operates a web site that reports a recommended maximum tensile stress limit for quartz as 1000 psi. This GE web site (http://www.gequartz.com/en/tools.htm) also allows the user to calculate sag and stress under a variety of mechanical clamping/support arrangements and thermal conditions. The most typical clamping or support arrangement for quartz used as a round window, is as illustrated in FIG. 1. That is, the opposing major surfaces of the quartz are clamped along both peripheral edge margins. As mentioned above, quartz can be used in an unclamped mounting configuration, but a thicker window, as compared to the clamped mounting, would be required.

While the window and cooperating chamber configuration of FIG. 1 are generally effective for their intended purpose, the present invention recognizes a number of concerns. Initially, it is noted that inner surface 22 of the window is inset, by a distance d, with respect to an inner surface 40 of the chamber wall, thereby forming an inset region 42. In effect, peripheral step 26 appears as a protrusion with respect to inner surface 22 of the window. This arrangement is considered by the present invention to be of concern, for example, in instances where it is desirable to place a treatment object as close as possible to window 16. That is, the presence of inset distance d may operate as a minimum separation between the treatment object and the window. This minimum separation, in turn, contributes to a minimum separation distance between the treatment object and a treatment source such as, for example, a heating arrangement that is positioned on the opposite side of the window. It is recognized by the present invention that certain process results such as process uniformity, control and process rate can be dependant on the separation distance between the treatment object and the treatment source. Frequently, decreasing this separation distance results in improving process uniformity, process control and process rate. In this regard, it should be appreciated any structure such as, for example, a wafer end-effector, that is used to transfer a wafer (not shown) into and out of the treatment chamber, or a wafer susceptor (not shown), that is used to support a semiconductor wafer during the treatment process, may necessarily operate to extend the plane of the wafer in a way which would cause interference with inner chamber wall 40. If it is attempted, for instance, to move the wafer into inset region 42, as close as possible to inner window surface 22, such interference may be produced between inner chamber wall 40 and the wafer and/or the wafer susceptor which directly supports the wafer.

As a further concern with respect to FIG. 1 when the treatment used for treating substrates located in the interior of the treatment chamber is a plasma based process, a condition can develop such that an inner edge 44 of peripheral support step 26 can serve to focus electric field lines that arise from an electrical potential difference between the inner exposed surfaces of the peripheral support step 26 and another surface (not shown) in the treatment chamber. The different electrical potential on the other surface in the treatment chamber could result from the bias created by the application of radio frequency (RF) power to this other surface. The focusing that occurs at inner edge 44 is due to the geometric increase in the field line density that occurs at an edge, as compared to a flat surface. This localized high density of electric field lines and the curvature of the plasma sheath has the effect of attracting a higher concentration of positive ions to the inner edge 44 as compared to that concentration attracted to an adjacent flat surface. The concentration of ions to inner edge 44 can result in increased sputtering of the material that forms the peripheral support step 26. This sputtered material can result in unwanted contamination of substrates treated in the treatment chamber. The prior art has attempted to address this concern by simply filling inset region 42 with a suitable transparent material or an integral extension of the material which forms window 16. While this operates to provide a “smooth” chamber interior, the present invention considers the approach as problematic, since this approach does not decrease the separation between the wafer and heating arrangement

The present invention overcomes the foregoing concerns while providing still further advantages, as will be described in detail below.

### SUMMARY OF THE INVENTION

As will be discussed in more detail hereinafter, there is disclosed herein a chamber configuration and associated method relating to a window arrangement which forms part of the chamber configuration. In one aspect of the present invention, chamber means defines a chamber interior and further defines a window aperture having an aperture edge therearound and which leads into the chamber interior. A window, having a pair of opposing major surfaces and a peripheral sidewall configuration extending therebetween, is received in the window aperture with the peripheral sidewall configuration supported against the aperture edge such that the peripheral sidewall configuration and the aperture edge cooperate in a way which converts at least a portion of a biasing force, that urges the window into the window aperture, to a direction that is different from an applied direction of the biasing force and oriented against the aperture edge.

In another aspect of the present invention, a chamber wall arrangement defines a chamber interior and includes a wall thickness defining a window aperture therethrough to form an aperture edge around the window aperture. A window, having a pair of opposing major surfaces and a peripheral sidewall configuration extending therebetween, is received in the window aperture with the peripheral sidewall configuration supported against the aperture edge such that the peripheral sidewall configuration and the aperture edge cooperate in a way which converts at least a portion of a biasing force, that is applied in a direction of application that is at least generally normal to the opposing major surfaces of the window, to a direction that is away from the direction of application and against the aperture edge.

In still another aspect of the present invention, a chamber wall arrangement defines a chamber interior and includes a wall thickness defining a window aperture therethrough between an inner chamber surface and an outer chamber surface so as to form an aperture edge which defines the window aperture. At least one portion of the aperture edge, surrounding the window aperture, is arranged at an oblique angle with respect to the inner chamber surface and the outer chamber surface. A window, having a pair of opposing major surfaces and a peripheral sidewall configuration, extends between the opposing major surfaces and includes a window edge surface, around the window, which is arranged at a complementary angle to the oblique angle. The window is received in the window aperture such that the window edge surface is in a confronting relationship with the portion of the aperture edge.

In a continuing aspect of the present invention, a chamber wall arrangement defines a chamber interior and includes chamber means for defining a chamber interior and for defining a window aperture having an aperture edge therearound. A window includes a pair of opposing major surfaces and a peripheral sidewall configuration extending between the opposing major surfaces. The window is receivable in the window aperture with the peripheral sidewall configuration supported against the aperture edge such that the peripheral sidewall configuration and the aperture edge cooperate in a way which converts at least a portion of a biasing force, that is applied to one of the opposing major surfaces of the window, to a direction that is oblique with respect to an orientation of the biasing force and which is extended against the aperture wall.

### BRIEF DESCRIPTION OF THE DRAWINGS

The present invention may be understood by reference to the following detailed description taken in conjunction with the drawings briefly described below.

FIG. 1 is a diagrammatic, partially cutaway view, in elevational cross-section, showing a window arranged in a prior art processing chamber configuration.

FIG. 2 is a diagrammatic, partially cutaway view, in an elevational cross-section, showing a window configuration forming part of an overall chamber configuration that is produced in accordance with the present invention.

FIG. 3 is a diagrammatic, partially cutaway view, in an elevational cross-section, that is further enlarged with respect to the view of FIG. 2, showing additional details of the window arrangement of the present invention including clamping, sealing and heat protective provisions.

FIG. 4 is another diagrammatic, partially cutaway view, in an elevational cross-section, that is further enlarged with respect to the view of FIG. 2, showing an alternative configuration of the window formed using a opaque peripheral quartz ring, in addition to showing additional details with respect to the relationship between the window and the support structure which defines the window aperture, as well as illustrating a capability to “outset” the window with respect to an interior surface of the chamber, in accordance with the present invention.

FIG. 5 is a diagrammatic, exploded perspective view showing components of the highly advantageous Wedge Window arrangement of the present invention in a spaced-apart relationship.

### DETAILED DESCRIPTION OF THE INVENTION

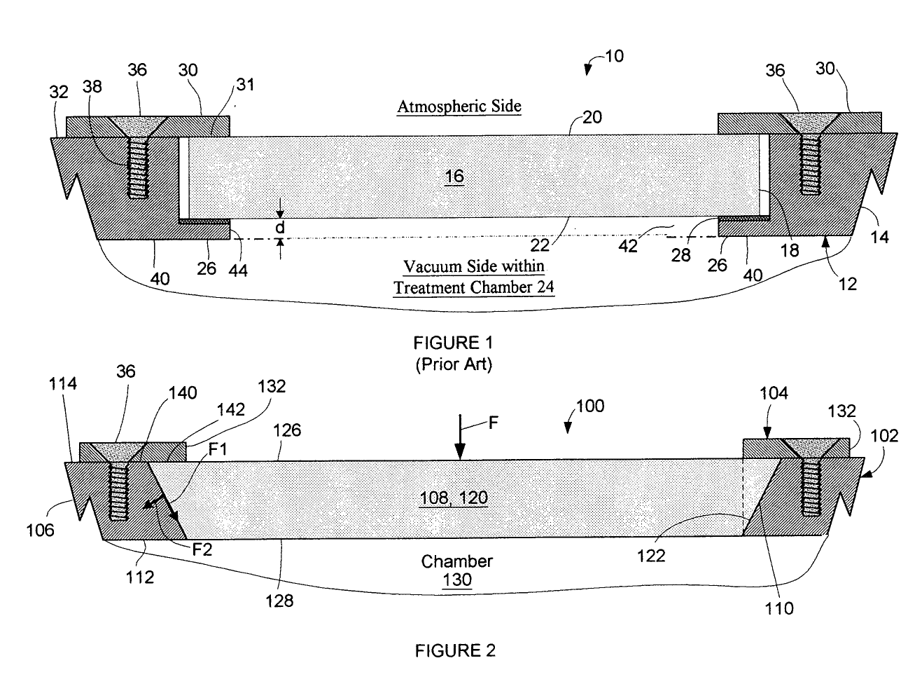

Turning to the drawings, wherein like components are designated by like reference numerals throughout the various figures, and having previously described FIG. 1, attention is initially directed to FIG. 2. The latter diagrammatically illustrates a system 100 including a chamber arrangement 102 supporting a window arrangement 104 that is produced in accordance with the present invention. The chamber arrangement may be formed using suitable materials including, but not limited to aluminum, stainless steel and titanium. It is noted that features of the various embodiments and implementations described herein may be combined in any suitable manner. Further, the drawings are not to scale and have been presented in a way that is intended to enhance the reader's understanding.

Continuing to refer to FIG. 2, chamber arrangement 102 includes a chamber wall 106 having a thickness which defines a window aperture 108 therethrough that is surrounded by an aperture edge 110. The aperture edge extends between a pair of inner and outer chamber surfaces that are indicated by the reference numbers 112 and 114. A window 120 is received in window aperture 108. Window 120 includes a peripheral sidewall configuration 122 which extends between a pair of outer and inner opposing major surfaces that are indicated by the reference numbers 126 and 128, respectively. Inner major surface 128 serves to define a portion of the interior periphery of chamber arrangement 102, surrounding a treatment chamber 130. While window 120 may be referred to herein as a “quartz” window, it is to be understood that any suitable material either currently available, or yet to be developed, may be used to fabricate the window. Such materials include, but are not limited to quartz, polycrystalline aluminum-oxynitride, sapphire and a wide variety of glasses. Only a portion of the chamber arrangement has been shown for purposes of illustrative convenience, however, it is to be understood that the overall treatment chamber may be formed through the cooperation of any number of walls that are arranged in any suitable manner, as well as in any suitable geometric form. As examples, the treatment chamber may be cylindrical, square or of any suitable ortho-rectangular configuration

Still referring to FIG. 2, aperture edge 110 is oblique or sloped with respect to opposing major surfaces 126 and 128 of window 120, as well as being oblique with respect to chamber inner and outer surfaces 112 and 114 in a way which forms an inverted frustoconical shape, in the view of the figure. Peripheral sidewall configuration 122 of window 120 is sloped having an angle which is complementary to the slope of aperture edge 110 such that the peripheral sidewall configuration, at any particular position along its edge, forms a surface which is oblique with respect to opposing major surfaces 126 and 128 of the window. Hence, window 120 is frustoconical in configuration in a manner which is inverted, as compared to the configuration of window aperture 108. As will be described further, window 120 may have a peripheral sidewall configuration in the form of a closed polygon, rather than being circular. Of course, noncircular, but continuous shapes such as, for example, ellipsoidal can be used. Accordingly, as examples, the window may be in the form of a frusto-pyramid or other such frusto-geometric form.

Although not a requirement, window 120 and chamber wall 106 may be of an equal thickness. In this instance, the peripheral sidewall configuration of the window may be configured to cooperate with aperture edge 110 such that the outer and inner surfaces, 126 and 128, of the window are in an aligned relationship with the outer and inner surfaces, 112 and 114, of the chamber wall, respectively. Specific details with respect to one highly advantageous configuration for sealing window 120 in the window aperture will be provided below.

Window 120 may be urged or biased into window aperture 108 using a compression ring 132 that is configured to surround and overlap a peripheral edge margin 140 of outer surface 114 of the chamber wall, as well as a peripheral edge margin 142 of surface 126 of window 120. In one implementation, compression ring 132 is held in positioned by a plurality of threaded fasteners 36 (only two of which are shown), although any suitable fastening devices and arrangement may be used for this purpose. Moreover, as will be further described, in some implementations, compression ring 132 or an equivalent mechanical arrangement may be unnecessary, depending on factors such as the orientation of the force of gravity, the weight of window 120 and its surface area. Irrespective of the specific way in which a biasing force is derived for purposes of urging window 120 into window aperture 108, that biasing force is utilized in a highly advantageous way based on the configurations of aperture edge 110 of the window aperture in cooperation with the form of peripheral sidewall configuration 122 of window 120, as will be described immediately hereinafter.

With continuing reference to FIG. 2, a biasing force F urges window 120 into window aperture 108. Biasing force F can be produced in any suitable manner, such as through the use of a clamping arrangement, as illustrated, produced by gravity, or any suitable combination of sources. Of course, the window arrangement may be oriented such that the force of gravity biases window 120 out of window aperture 108, in which case some suitable mechanism, such as a clamping ring is necessary for urging the window into the aperture, at least until a pressure differential can overcome the force of gravity. Irrespective of the specific source of biasing force F, the peripheral configuration of window 120 and window aperture 108 operates in a highly advantageous manner with respect thereto. Specifically, biasing force F is resolved into components F1 and F2. The former is parallel to aperture edge 110, the latter, however, is normal to aperture edge 110, and applied directly thereagainst. Stated in a slightly different way, peripheral sidewall configuration 122 of the window and aperture edge 110 cooperate in a way which converts at least a portion of biasing force F, that is applied generally normal to the opposing major surfaces of the window, to a direction that is different, oblique to, sloped or away from the direction of application of biasing force F and against the aperture edge.

Resolved force components F1 and F2 serve to retain window 120 within the window aperture in a highly advantageous way by using only peripheral sidewall configuration 122 of the window. There is no contact, for support purposes or otherwise, with inner surface 128 of the window. Accordingly, interior surface 128 of the window can be positioned, as desired, in relation to inner surface 112 of chamber wall 106 in a way which provides for a continuous or coplanar surface as the interior of the treatment chamber in relation to the inner chamber wall.

Referring to FIG. 1 in conjunction with FIG. 2, the highly advantageous “Wedge Window” configuration that has been brought to light by the present invention is considered to resolve the concerns described above with regard to prior art window configurations such as are represented by FIG. 1. By avoiding contact with the inner surface of the window for use in supporting the window, the present invention recognizes that an offset between the chamber interior and the window interior can be eliminated. The prior art, by using the inner surface of the window for support purposes, requires the support structure of the chamber which surrounds the window to, in effect, reach across the peripheral sidewall of the window, thereby creating an inner aperture diameter, in the case of a circular window, having a smaller diameter than the diameter of the inner surface of the window itself. Moreover, as will be further described, in some cases it may be desirable for window and its inner surface to protrude slightly inward, toward the treatment object, to facilitate positioning of the treatment object as closely as possible to the window inner surface. The Wedge Window of the present invention provides benefits any time the distance between the internal window surface (window surface facing the substrate to be processed) and the substrate is to be minimized and/or the distance between the substrate and an external object needs to be minimized. In the instance of the latter, it is to be understood that the window arrangement of the present invention may support a pressure differential in either direction across the thickness of the window. When pressure differential forces oppose window biasing forces, however, care should be taken to insure that the biasing forces exceed pressure forces by an amount that is sufficient to maintain a seal about the window. Moreover, referring to FIG. 2, there is no requirement for “inner surface” 128 of the window to face the interior of a treatment chamber. In some cases, it may be desirable to “invert” the configuration of the window such that the smaller diameter of the window is positionable in relation to the outer surface of a supporting chamber wall. In this regard, terminology used throughout this description such as, for example, “inner” and “outer”, has been applied for descriptive purposes only and is in no way intended as being limiting.

Computer modeling has shown that the reduced separation distance achieved by the window arrangement of the present invention shown in FIG. 2, as compared to FIG. 1, results in a significant improvement in the thermal uniformity that is achievable in a particular RTP substrate processing environment. Modeling was performed using a circular window configured in the manner described with regard to FIG. 2, supporting a one atmosphere pressure differential. The round shape was chosen to minimize the volume of the process environment, to minimize the mass and size of quartz required for the window and to minimize the stress applied to the quartz window. A square or rectangular shape could have been used, for example, in the instance of relaxed operating requirements.

Referring again to FIG. 2, it should be appreciated that peripheral sidewall configuration 122 of the window and aperture edge 110 of aperture 108 may be configured in a number of alternative ways, while still remaining within the scope of the present invention. In particular, while the oblique surfaces comprising the window peripheral sidewall and the aperture edge are shown as extending completely between the inner and outer surfaces of the window and completely through the thickness of chamber wall 106 as continuous surfaces, this is not a requirement for either, so long as at least a portion of the window peripheral sidewall and the aperture edge are configured to cooperate in a way which converts at least a portion of a biasing force, applied at least generally against the outer window surface, to a direction therebetween that is away from or oblique with respect to the direction of application of the biasing force.

In the implementation illustrated by FIG. 2, compression ring 132 forms an inner diameter which is equal to and coaxial with the diameter of the window aperture at inner chamber surface 128. In this way, peripheral edge margin 140 is sufficiently wide to provide for adequate distribution of clamping forces, while blocking no radiation attempting to pass through window 120 in a direction that is parallel to biasing force F. It is to be understood, however, that this is not a requirement and that, based on design objectives, compression ring 132 may have any suitable inner diameter that is greater or less than the diameter of inner surface 128 of the window. In the instance of a window in the form of a closed polygon (e.g., triangular, square, rectangular, hexagonal, and so on) the cross-sectional view of FIG. 2 is unchanged, except that the window surfaces may be characterized, in some cases, by a width, as opposed to a diameter. In any case, the inner edge of the compression clamp may be aligned normal with the outer edge or periphery of inner surface 128 of the window.

A prototype of the highly advantageous window and support structure of the present invention has been constructed consistent with the foregoing descriptions wherein the angle of the beveled peripheral edge of the quartz window is 45° from normal to the diameter of the outer major surface of the window. This prototype design has been successfully tested with a 1-atmosphere pressure differential (biasing the window into the window aperture) and with both a 1-atmosphere pressure differential and with a heat source to simulate the thermal gradient that would arise from energy radiated from a hot substrate in a typical RTP system.

Referring briefly to FIG. 1, it will be remembered that the prior art uses a gasket 28 for separating the window from the bottom clamp surface. This gasket is usually a flat gasket, an L-shaped gasket or an o-ring type gasket which serves to avoid direct metal to quartz contact and helps distribute the force that forms at the periphery of the internal window surface against peripheral support step 26, when the volume facing inner surface 22 of the window is evacuated, thereby creating a pressure differential across the diameter of the window and/or when the window is clamped between top and bottom peripheral support surfaces. A gasket to prevent direct metal to quartz contact between top clamp 30 and the quartz is preferable but not always necessary. In contrast with the present invention, however, windows having the design of FIG. 1 typically do not use a gasket arranged about the outer diameter of the window, as typically no force is applied to the outer diameter. While it is recognized that prior art windows having the design of FIG. 1 could utilize a vacuum seal around the outer diameter of the window, they would also typically require a gasket of some design to separate the window from the bottom clamp surface so as to prevent point loading of the window material to the metal support surface.

Referring to FIG. 2, however, with the Wedge Window of the present invention, the inner or “bottom” support step has been eliminated, with all window support applied to the sloped outer edge of the window. With the foregoing in mind, further details will be provided immediately hereinafter describing one highly advantageous configuration for sealing the window of the present invention in its window aperture, as well as other highly advantageous design concepts.

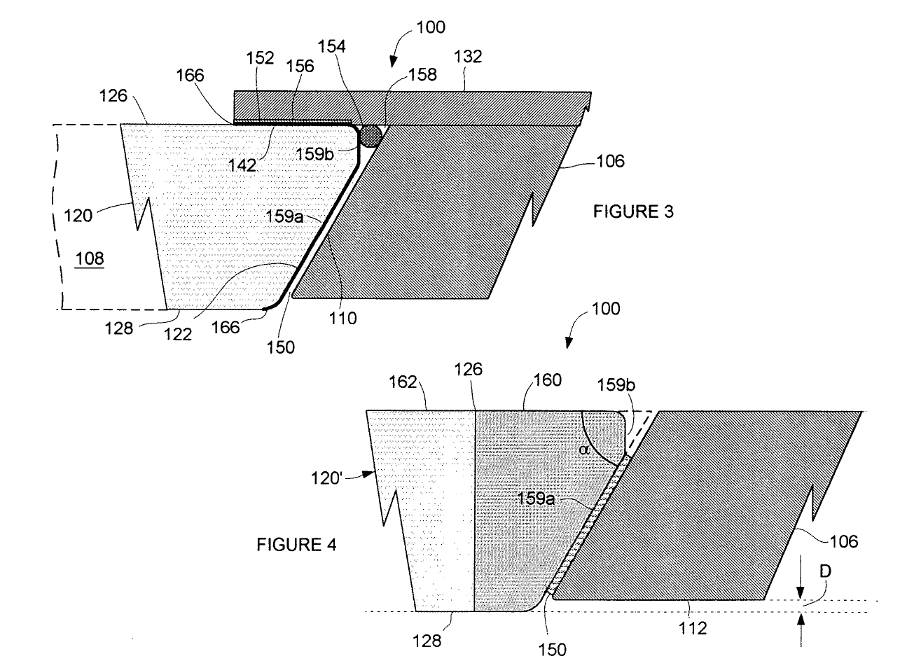

Turning to FIG. 3, the Wedge Window of the present invention is shown in a partial, enlarged cutaway view. A gasket 150 is in an inverted frustoconical configuration and is positioned between peripheral sidewall configuration 122 of window 120 and aperture edge 110 of the window aperture. Gasket 150 may be referred to as a “compliance” gasket which may be formed, for example, from a compressible polymer such as polyimide, fluorosilicone, fluorocarbon or other suitable compressible gasket materials having a suitable durometer. The explanation for the reference to “compliance” lies with the requirement that this gasket be capable of acting as a compliant body between the quartz window and the metallic aperture-defining wall serving as a support surface. That is, gasket 150 operates to distribute the forces that develop as a result of biasing force, pressure differential and/or thermal expansion of the window and chamber wall very uniformly in a way so as to evenly distribute the biasing force which avoids development of localized high stress points.

Based on the aforementioned modeling, acceptable parameters have been defined with respect to the material properties of compliance gasket 150 so as to meet safety guidelines for maximum allowable stress as defined by GE™. With conventional vacuum window designs, such as shown in FIG. 1, the compliancy of the gasket material is less sensitive and the range of material properties is wider than those preferred for gasket 150.

In typical prior art vacuum window designs, such as exemplified by FIG. 1, the gasket that prevents quartz to metal contact also serves as the seal that is required to maintain the required vacuum integrity. It is noted that vacuum integrity is usually defined as a maximum allowable leak rate. As will be described immediately hereinafter, the present invention recognizes that the sealing function can be separated from the compliance function with accompanying benefits.

Referring again to FIG. 3, system 100 may be configured, in one highly advantageous implementation, so as to separate the functions of (1) evenly distributing biasing forces and pressure differential produced forces, from the function of (2) achieving a vacuum seal. It is important to understand that these two functions can be incorporated into a single seal that serves as both the compliance gasket and the vacuum seal. In the present example, however, it is elected to separate these functions such that different materials can be separately or independently selected which most closely match the optimum properties that are desired for each function. It is noted that, where both functions are to be performed by gasket 150, the gasket should be formed having continuous sealing surfaces. In most cases, this gasket, in a frustoconical shape, will be a custom manufactured part. If gasket 150 is produced having a seam, this seam is necessarily sealed to achieve repeatable and reliable vacuum integrity. Where gasket 150 serves only for providing the requisite compliance, it need not be continuously formed. Depending upon the process being implemented, it may be important that the gasket material(s) and o-ring materials do not contaminate the process environment. Therefore, these materials should be selected with this factor in mind. Contamination could result, for example, from formation of particles and/or products evolved from decomposition of the gasket materials due to thermal and/or chemical processes.

The vacuum sealing function is relegated to an o-ring type seal 154 used in conjunction with compression plate 132. Metal to quartz contact is avoided by using a circular gasket 156 between compression plate 132 and peripheral edge margin 142 of window 120. It is noted that the thickness of gasket 156 has been exaggerated for illustrative purposes and that the contact surface of compression plate 132 can be flat. Moreover, it is noted that circular (or annular ring) gasket 156 may not always be necessary. The configuration of window 120 received in window aperture 108 of chamber wall 106 cooperates with compression plate 132 in a way which forms a seal pocket 158 which receives o-ring 154. O-ring pocket 158 decreases in width as compression plate 132 forces the o-ring into the pocket such that an adequate seal is achieved. In this regard, o-ring seal 154 contacts three surfaces: (1) the outer diameter of window 120; (2) a portion of aperture edge 110 and, (3) seal compression plate 132 in order to form a suitable vacuum seal. O-ring 154 may be formed from any suitable material including, but not limited to nitrile, neoprene, silicone, ethylene-propylene, fluorosilicone or any of the wide variety of fluoroelastimers developed for vacuum sealing applications.

Still referring to FIG. 3, peripheral sidewall configuration 122 includes a series of surfaces which extend between opposing major surfaces 126 and 128. These surfaces include a support surface 159a, which is oblique with respect to the opposing major surfaces and engages gasket 150, and a sealing surface 159b, which is at least generally normal with respect to the opposing major surfaces and which engages o-ring seal 154. As surfaces of revolution, support surface 159a takes a frustoconical form while sealing surface 159b provides a cylindrical form.

Referring to FIG. 4, in one alternative embodiment of system 100, a window 120′ is used which is formed from two different types of quartz materials. This configuration is considered to be advantageous in order to minimize lamp radiative energy from impinging directly on either compliance gasket 150 or vacuum o-ring 154 (FIG. 3). The use of an opaque quartz outer ring 160, that is sealed to a clear quartz center disk 162, is intended to prevent excessive heating of both compliance and sealing materials. In this regard, a number of different opaque materials meet the requirements for opaque quartz ring 160. For example, opaque quartz, if formed from inclusion of very small gas bubbles or a dopant (such as hafnium oxide), gives the quartz a white appearance. It is noted that the fabrication of a multi-piece quartz window, as illustrated, is considered to be within the capability of one having ordinary skill in the art in view of this overall disclosure. While compression plate 132 and o-ring seal 154 have not been shown in the present example, for purposes of illustrative clarity, it is to be understood that these components are present. A contact angle α characterizes the angular relationship between support surface 159a and opposing major surfaces 126 and 128. As is further described below, acceptable values for contact angle α range from approximately 25 degrees to 85 degrees.

Still referring to FIG. 4, it is noted that window 120′, in this implementation, as well as in the implementation of FIG. 3, has a thickness which is greater than the thickness of chamber wall 106 such that inner surface 128 is inset into what is typically the interior of the treatment chamber with respect to chamber inner surface 112. Accordingly, a highly advantageous clearance D is provided between the interior of the chamber wall and components within the treatment chamber such as, but not limited to, for example, a wafer (not shown) and/or a wafer susceptor (not shown) and/or a wafer end-effector (not shown).

Referring again to FIG. 3, the need for the use of two different quartz materials may be eliminated, thereby forming window 120 from only clear quartz material and still protecting the compliance and sealing material from excessive thermal heating, by coating an outer portion of window 120 with a reflective coating 166—such as, for example, a “white” layer (e.g., aluminum oxide and titanium dioxide) or a highly reflective metal layer (e.g., gold, aluminum, silver, and other metals). Since certain metals (such as gold and silver may, for some processes, be a potential contaminant, these metals can be over-coated with a suitable barrier layer to prevent contamination of the process environment. Further, reduction or elimination of thermal damage to the compliance and sealing materials is contemplated by frosting the outer sloped edge of the quartz or the outer sloped edge and some portion of the outer top and bottom peripheral window surfaces, for example, in the region corresponding to coating 166, so long as the surface roughness does not impair the vacuum integrity. In applications where there is little or no potential for thermal damage to the gaskets, a single clear quartz window member can be used without any additional coating or opaque quartz protective material.

Dimensions for the thickness of the window, the sloped angle of the edge of the window, the requirement for protecting the gasket from damage from excessive heating, the use of a single compliance gasket for distribution of generated stress and vacuum sealing or separate gaskets will all depend on the specifics of a particular application. Again, if thermal damage to the compliance and/or sealing material (whether performed by one gasket member or by separate components) is not an issue, no precautions to prevent thermal damage will be required. Further, the highly advantageous Wedge Window of the present invention will function in any spatial orientation.

An analysis for the use of the wedge window of the present invention in an RTP system will now be detailed including useful design parameters. A stress analysis of the Wedge Window, in a circular form, was performed using NASTRAN finite element analysis software. The quartz window was configured consistent with FIG. 4, consisting of two types of quartz, clear quartz at the center and opaque quartz at its edge. For purposes of the analysis, the inside of the chamber is maintained in vacuum such that the quartz is stressed by outside atmospheric pressure. Also, the chamber is stressed thermally since the window will be primarily heated from the inside and cooled convectively at the outside surface by air (which air serves to cool the heating arrangement, as well as the window). For purposes of the analysis, it has been assumed that window temperature varies between 600° C. (1112° F.) and 300° C. (572° F.). Also, the following additional assumptions were made for the analysis:
1. Gravitational effect is ignored, as its effect is small.
2. There is no slip between window and gasket, and gasket to a stainless support wall and all the nodes among these materials are connected all the time.
3. Material properties do not vary with temperature.
4. The Stainless steel is round and the outside edge of the stainless steel is fixed.
5. There is no effect at the boundary of the clear and opaque quartz.
6. Initial equipment temperature is 30° C. (86° F.).

Referring to FIG. 4, based on this analysis, the following are considered as useful design parameters for the quartz window of the present invention:

| | |
|---|---|
| Contact Angle α = | 60 degrees |
| Gasket 150 Thickness = | 40 mil |

In this regard, contact angles in a range from approximately 25° to 85° are considered as being useful. Gasket 150 thickness may range from approximately 0.5 mm to 1.5 mm in view of a particular application. With this design, the maximum tensile stress in the quartz window will be

| | |
|---|---|
| Pressure Induced | 555 psi |
| Thermal Stress | 956 psi |
| Combined Stress | 795 psi |

All the above stresses are less than the 1000 psi upper safety limit recommended for quartz by General Electric (GE) Company™. A high temperature polyimide was used for the compliance gasket and a fluroelastomer was used for the o-ring.

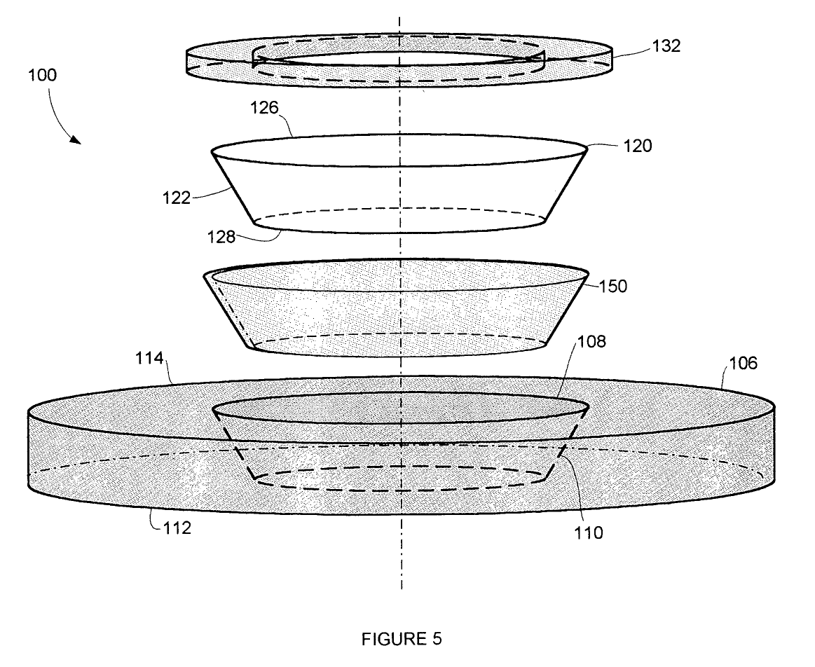

Attention is now directed to FIG. 5 which provides a diagrammatic, exploded perspective view of window arrangement 100. Since all illustrated components have been described in detail above, such descriptions will not be repeated for purposes of brevity. In the present figure, a circular cut-away section of chamber wall 106 is illustrated.

Although each of the aforedescribed physical embodiments have been illustrated with various components having particular respective orientations, it should be understood that the present invention may take on a variety of specific configurations with the various components being located in a wide variety of positions and mutual orientations. Furthermore, the methods described herein may be modified in an unlimited number of ways, for example, by reordering, modifying and recombining the various steps. Accordingly, it should be apparent that the arrangements and associated methods disclosed herein may be provided in a variety of different configurations and modified in an unlimited number of different ways, and that the present invention may be embodied in many other specific forms without departing from the spirit or scope of the invention. Therefore, the present examples and methods are to be considered as illustrative and not restrictive, and the invention is not to be limited to the details given herein, but may be modified at least within the scope of the appended claims.

1. As part of a chamber configuration, a window arrangement comprising:
chamber means for defining a chamber interior and for defining a window aperture having an aperture edge therearound; and
a window having a pair of opposing major surfaces and a peripheral sidewall configuration extending therebetween, which window is receivable in said window aperture with said peripheral sidewall configuration supported against said aperture edge such that the peripheral sidewall configuration and the aperture edge cooperate in a way which converts at least a portion of a biasing force, that urges the window into the window aperture, to a direction that is different from an applied direction of said biasing force and oriented against the aperture edge.

2. The window arrangement of claim 1 wherein the applied direction of the biasing force is at least generally normal to at least one of said opposing major surfaces.

3. The window arrangement of claim 1 wherein said window is formed from a material that is at least generally transparent in a particular range of the electromagnetic spectrum.

4. The window arrangement of claim 1 wherein the window is formed from quartz.

5. The window arrangement of claim 1 wherein said peripheral sidewall configuration of the window defines a window edge surface that is oblique with respect to each of the opposing major surfaces and which cooperates with said aperture edge for use in converting said biasing force.

6. The window arrangement of claim 5 wherein said window edge surface forms a continuous surface surrounding said window.

7. The window arrangement of claim 5 wherein said window edge surface extends between said opposing major surfaces.

8. The window arrangement of claim 5 wherein said window edge surface forms an angle in a range from approximately 25 degrees to 85 degrees with one of said opposing major surfaces.

9. The window arrangement of claim 5 wherein said portion of the aperture edge forms an angle with one of said opposing major surfaces that is selected as one of approximately 45 degrees and 60 degrees.

10. The window arrangement of claim 5 wherein said window edge surface is one of a series of peripheral edge surfaces which connect the opposing major surfaces such that the window edge surface forms a truncated cone, as a surface of revolution, and another one of the series of peripheral edge surfaces, immediately adjacent to the window edge surface forms a cylinder, as a surface of revolution.

11. The window arrangement of claim 1 wherein at least a portion of said aperture edge is oblique with respect to said opposing major surfaces, when said window is received in the window aperture, for use in converting said biasing force.

12. The window arrangement of claim 11 wherein said portion of the aperture edge forms an angle in a range from approximately 25 degrees to 85 degrees with one of said opposing major surfaces.

13. The window arrangement of claim 12 wherein said portion of the aperture edge forms an angle with one of said opposing major surfaces that is selected as one of approximately 45 degrees and 60 degrees.

14. The window arrangement of claim 11 wherein said portion of the aperture edge forms a continuous surface surrounding said window aperture.

15. The window arrangement of claim 14 wherein said chamber defining means includes an inner surface and an outer surface and said continuous surface extends from said inner surface to said outer surface.

16. The window arrangement of claim 11 wherein said aperture edge and the peripheral sidewall configuration of the window are segmented such that the window has a window outline in the form of a closed polygon.

17. The window arrangement of claim 16 wherein said window outline includes at least three segments and each segment forms a continuous surface extending between the opposing major surfaces.

18. The window arrangement of claim 11 wherein said peripheral sidewall configuration of the window defines a window edge surface which cooperates with said portion of the aperture edge for use in converting said biasing force.

19. The window arrangement of claim 18 wherein said window edge surface is in a confronting relationship with said portion of the aperture edge when the window is received in the window aperture.

20. The window arrangement of claim 18 wherein said window is at least generally circular and said window edge surface extends between the opposing major surfaces such that the window is at least generally frustoconical in shape.

21. The window arrangement of claim 18 wherein a first one of the opposing major surfaces of the window is inward with respect to the chamber interior, when the window is received in the window aperture, and a second one of the opposing major surfaces is outward with respect to the chamber interior and the first major surface defines a first area that is less than a second area that is defined by the second major surface.

22. The window arrangement of claim 21 wherein said first and second ones of the opposing major surfaces are circular including first and second diameters, respectively, and including a seal compression clamp positioned to urge the window into the window aperture using a peripheral edge portion of said second major surface, said seal compression clamp defining a circular opening therethrough with an opening diameter that is at least as large as the first diameter of the first major surface and said seal compression clamp positioned coaxially with the first and second major surfaces to align the circular opening of the clamp at least with the first major surface of the window.

23. The window arrangement of claim 21 wherein said window and said window aperture are configured for maintaining a negative pressure differential between the chamber interior and the surrounding environment.

24. The window arrangement of claim 23 wherein said window is urged into said window aperture by said negative pressure differential so as to contribute to said biasing force and, in turn, to increase the converted portion of said biasing force.

25. The window arrangement of claim 18 wherein said window edge surface forms an oblique angle with one of said opposing major surfaces.

26. The window arrangement of claim 18 including a gasket positioned between the window edge surface and the aperture edge in a way which provides for compliant movement of the window with respect to the chamber arrangement.

27. The window arrangement of claim 26 wherein the gasket is formed from a polymer material.

28. The window arrangement of claim 18 including an o-ring positioned between the peripheral sidewall configuration of the window and the aperture edge in a way which seals the chamber interior against ambient pressure.

29. The window arrangement of claim 28 wherein the o-ring is formed from a polymer material.

30. The window arrangement of claim 28 including a gasket positioned between the peripheral sidewall configuration and the aperture edge in a way which provides for compliant movement between the window and the chamber defining means as said o-ring seals the chamber interior.

31. The window arrangement of claim 30 wherein said gasket is inside the seal provided by the o-ring with respect to the chamber interior.

32. The window arrangement of claim 31 including a seal compression clamp which urges the window into the window aperture to, in turn, bias the window edge surface into said resilient gasket while biasing the o-ring to a position between the peripheral edge configuration and the aperture edge to form said seal at least when the chamber interior is equalized with ambient pressure.

33. The window arrangement of claim 32 wherein said window is configured to define an o-ring pocket between the peripheral sidewall configuration and the aperture edge such that a width of the o-ring pocket decreases as the o-ring is biased further therein.

34. The window arrangement of claim 1 wherein at least a portion of the peripheral sidewall configuration is treated in a way which enhances its reflectivity.

35. The window arrangement of claim 34 wherein said portion of the peripheral sidewall configuration is coated with a metallic layer.

36. The window arrangement of claim 1 wherein at least a portion of the peripheral sidewall configuration is surface roughened to enhance reflectivity.

37. The window arrangement of claim 1 wherein said window is arranged to provide a view of the chamber interior from a position that is exterior thereto.

38. The window arrangement of claim 1 wherein said window is positioned for use in executing at least a portion of a treatment process through the window and upon a treatment object that is supported within the chamber interior with a pressure differential across said window.

39. In providing a chamber configuration having a window arrangement, a method comprising:
forming chamber means for defining a chamber interior and for defining a window aperture having an aperture edge therearound; and
configuring a window having a pair of opposing major surfaces and a peripheral sidewall configuration extending therebetween, which window is receivable in said window aperture with said peripheral sidewall configuration supported against said aperture edge such that the peripheral sidewall configuration and the aperture edge cooperate in a way which converts at least a portion of a biasing force, that urges the window into the window aperture, to a direction that is different from an applied direction of said biasing force and oriented against the aperture edge.

40. The method of claim 39 including selecting the applied direction of the biasing force as at least generally normal to at least one of said opposing major surfaces.

41. The method of claim 39 wherein said window is formed from a material that is at least generally transparent in a particular range of the electromagnetic spectrum.

42. The method of claim 39 wherein the window is formed from quartz.

43. The method of claim 39 including using said peripheral sidewall configuration of the window to define a window edge surface that is oblique with respect to each of the opposing major surfaces and which cooperates with said aperture edge for use in converting said biasing force.

44. The method of claim 43 including establishing said window edge surface as a continuous surface surrounding said window.

45. The method of claim 43 wherein said window edge surface extends between said opposing major surfaces.

46. The method of claim 43 wherein configuring includes forming said window edge surface at an angle in a range from approximately 25 degrees to 85 degrees with one of said opposing major surfaces.

47. The method of claim 43 wherein configuring includes forming said portion of the aperture edge at an angle with one of said opposing major surfaces that is selected as one of approximately 45 degrees and 60 degrees.

48. The method of claim 43 including shaping said window edge surface as one of a series of peripheral edge surfaces which connect the opposing major surfaces such that the window edge surface forms a truncated cone, as a surface of revolution, and another one of the series of peripheral edge surfaces, immediately adjacent to the window edge surface forms a cylinder, as a surface of revolution.

49. The method of claim 39 wherein at least a portion of said aperture edge is formed oblique with respect to said opposing major surfaces, when said window is received in the window aperture, for use in converting said biasing force.

50. The method of claim 49 wherein said portion of the aperture edge forms an angle in a range from approximately 25 degrees to 85 degrees with one of said opposing major surfaces.

51. The method of claim 50 wherein said portion of the aperture edge forms an angle with one of said opposing major surfaces that is selected as one of approximately 45 degrees and 60 degrees.

52. The method of claim 49 including forming said portion of the aperture edge as a continuous surface surrounding said window aperture.

53. The method of claim 52 wherein said chamber defining means includes an inner surface and an outer surface and said continuous surface is formed to extend from said inner surface to said outer surface.

54. The method of claim 49 including segmenting said aperture edge and the peripheral sidewall configuration of the window such that the window has a window outline in the form of a closed polygon.

55. The method of claim 54 wherein said window outline is segmented including at least three segments and each segment forms a continuous surface extending between the opposing major surfaces.

56. The method of claim 49 wherein said peripheral sidewall configuration of the window defines a window edge surface which cooperates with said portion of the aperture edge for use in converting said biasing force.

57. The method of claim 56 including arranging said window edge surface in a confronting relationship with said portion of the aperture edge when the window is received in the window aperture.

58. The method of claim 56 wherein said window is at least generally circular and said method includes extending said window edge surface between the opposing major surfaces such that the window is at least generally frustoconical in shape.

59. The method of claim 56 including arranging a first one of the opposing major surfaces of the window inward with respect to the chamber interior, when the window is received in the window aperture, such that a second one of the opposing major surfaces is outward with respect to the chamber interior and the first major surface defines a first area that is less than a second area that is defined by the second major surface.

60. The method of claim 59 including shaping said first and second ones of the opposing major surfaces as circular including first and second diameters, respectively, and including positioning a seal compression clamp in a way which urges the window into the window aperture using a peripheral edge portion of said second major surface, said seal compression clamp defining a circular opening therethrough with an opening diameter that is at least as large as the first diameter of the first major surface and said seal compression clamp positioned coaxially with the first and second major surfaces to align the circular opening of the seal compression clamp at least with the first major surface of the window.

61. The method of claim 59 wherein said window and said window aperture are configured for maintaining a negative pressure differential between the chamber interior and a surrounding environment.

62. The method of claim 61 including using said negative pressure differential to urge said window into said window aperture so as to contribute to said biasing force and, in turn, to increase the converted portion of said biasing force.

63. The method of claim 56 wherein said window edge surface is defined to form an oblique angle with one of said opposing major surfaces.

64. The method of claim 56 including positioning a gasket between the window edge surface and the aperture edge in a way which provides for compliant movement of the window with respect to the chamber arrangement.

65. The method of claim 64 including forming the gasket from a polymer material.

66. The method of claim 56 including locating an o-ring between the peripheral sidewall configuration of the window and the aperture edge in a way which seals the chamber interior against ambient pressure.

67. The method of claim 66 wherein the o-ring is formed from a polymer material.

68. The method of claim 66 including positioning a gasket between the peripheral sidewall configuration and the aperture edge in a way which provides for compliant movement between the window and the chamber defining means as said o-ring seals the chamber interior.

69. The method of claim 68 including arranging said gasket inside the seal provided by the o-ring with respect to the chamber interior.

70. The method of claim 69 including using a seal compression clamp to urge the window into the window aperture to, in turn, bias the window edge surface into said resilient gasket while biasing the o-ring to a position between the peripheral edge configuration and the aperture edge to form said seal at least when the chamber interior is equalized with ambient pressure.

71. The method of claim 70 wherein said window is configured to define an o-ring pocket between the peripheral sidewall configuration and the aperture edge such that a width of the o-ring pocket decreases as the o-ring is biased further therein.

72. The method of claim 39 including treating at least a portion of the peripheral sidewall configuration in a way which enhances its reflectivity.

73. The method of claim 72 including coating said portion of the peripheral sidewall configuration with a metallic layer.

74. The method of claim 39 including surface roughening at least a portion of the peripheral sidewall configuration to enhance reflectivity.

75. The method of claim 39 including arranging said window to provide a view of the chamber interior from a position that is exterior thereto.

76. The method of claim 39 including positioning said window for use in executing at least a portion of a treatment process through the window and upon a treatment object that is supported within the chamber interior with a pressure differential across said window.

77. As part of a chamber configuration, a window arrangement comprising:
a chamber wall arrangement defining a chamber interior and having a wall thickness defining a window aperture therethrough to form an aperture edge around the window aperture; and
a window having a pair of opposing major surfaces and a peripheral sidewall configuration extending therebetween, which window is receivable in said window aperture with said peripheral sidewall configuration supported against said aperture edge such that the peripheral sidewall configuration and the aperture edge cooperate in a way which converts at least a portion of a biasing force, that is applied in a direction of application that is at least generally normal to the opposing major surfaces of the window, to a direction that is away from said direction of application and against the aperture edge.

78. In producing a chamber configuration a method for providing a window arrangement, said method comprising:
providing a chamber wall arrangement defining a chamber interior and having a wall thickness defining a window aperture therethrough to form an aperture edge around the window aperture; and
forming a window having a pair of opposing major surfaces and a peripheral sidewall configuration extending therebetween, which window is receivable in said window aperture with said peripheral sidewall configuration supported against said aperture edge such that the peripheral sidewall configuration and the aperture edge cooperate in a way which converts at least a portion of a biasing force, that is applied in a direction of application that is at least generally normal to the opposing major surfaces of the window, to a direction that is away from said direction of applicaiton and against the aperture edge.

79. As part of a chamber configuration, a window arrangement comprising:
a chamber wall arrangement defining a chamber interior and having a wall thickness defining a window aperture therethrough between an inner chamber surface and an outer chamber surface so as to form an aperture edge which defines the window aperture and at least one portion of the aperture edge, surrounding the window aperture, that is arranged at an oblique angle with respect to said inner chamber surface and said outer chamber surface; and
a window having a pair of opposing major surfaces and a peripheral sidewall configuration extending therebetween including a window edge surface, around the window, which is arranged at a complementary angle to said oblique angle and which window is receivable in said window aperture such that said window edge surface is in a confronting relationship with said portion of the aperture edge.

80. In producing a chamber configuration having a window arrangement, a method comprising:
configuring a chamber wall arrangement defining a chamber interior and having a wall thickness defining a window aperture therethrough between an inner chamber surface and an outer chamber surface so as to form an aperture edge which defines the window aperture and at least one portion of the aperture edge, surrounding the window aperture, that is arranged at an oblique angle with respect to said inner chamber surface and said outer chamber surface; and
forming a window having a pair of opposing major surfaces and a peripheral sidewall configuration extending therebetween including a window edge surface, around the window, which is arranged at a complementary angle to said oblique angle and which window is received in said window aperture such that said window edge surface is in a confronting relationship with said portion of the aperture edge.

81. As part of a chamber configuration, a window arrangement comprising:
chamber means for defining a chamber interior and for defining a window aperture having an aperture edge therearound; and
a window having a pair of opposing major surfaces and a peripheral sidewall configuration extending therebetween, which window is received in said window aperture with said peripheral sidewall configuration supported against said aperture edge such that the peripheral sidewall configuration and the aperture edge cooperate in a way which converts at least a portion of a biasing force, that is applied to one of the opposing major surfaces of the window, to a direction that is oblique with respect to an orientation of the biasing force and which is oriented against the aperture wall.

82. In producing a chamber configuration having a window arrangement, a method comprising:
configuring chamber means for defining a chamber interior and for defining a window aperture having an aperture edge therearound; and
forming a window having a pair of opposing major surfaces and a peripheral sidewall configuration extending therebetween, which window is received in said window aperture with said peripheral sidewall configuration supported against said aperture edge such that the peripheral sidewall configuration and the aperture edge cooperate in a way which converts at least a portion of a biasing force, that is applied to one of the opposing major surfaces of the window, to a direction that is oblique with respect to an orientation of the biasing force and which is oriented against the aperture wall.
